(19) United States
(12) Patent Application Publication
(10) Pub. No.: US 2017/0203236 A1
(43) Pub. Date: Jul. 20, 2017

(54) Method of Treating Flowback Fluid from a Well

(71) Applicant: Noles Intellectual Properties, LLC, Washington, OK (US)

(72) Inventor: Jerry W. Noles, JR., Blanchard, OK (US)

(73) Assignee: Noles Intellectual Properties, LLC, Washington, OK (US)

(21) Appl. No.: 15/477,922

(22) Filed: Apr. 3, 2017

Related U.S. Application Data
(63) Continuation-in-part of application No. 14/527,390, filed on Oct. 29, 2014.

(51) Int. Cl. B01D 17/04; E21B 43/40; C02F 9/00

(52) U.S. Cl. CPC B01D 17/045; C02F 9/00; E21B 43/40; C02F 2305/02; C02F 2209/04; C02F 2209/06; C02F 2101/203

(57) ABSTRACT

A method and apparatus for treating flow back fluid from a well after a well completion process is disclosed. The method includes the steps of maintaining the pH of the flow back fluid at a certain level and introducing an oxidizing agent at a pressure greater than atmosphere into the fluid flow which reduces the amount of oxidizing agent needed. The flow back fluid which typically contains at least water, oil and solids is passed through a tubing bundle and an oil/rooter separation which may include a coalescing unit. Apparatus is also disclosed for carrying out the method.

This application is a continuation in part application of U.S. application Ser. No. 14/527,390 filed Oct. 29, 2014, the entire contents of which is expressly incorporated herein by reference thereto.

### BACKGROUND OF INVENTION

1. Field of the Invention

This invention is directed to a method and apparatus for treating flow back fluids from an oil or gas well after a completion process has been performed on an oil or gas well. An example is treating the flow back fluid after a fracturing process. The flow back fluid typically includes mostly water with added chemicals, proppant, other solids and salt water from the formation being treated.

Within recent years the oil and gas industry has developed the use of hydraulic fracturing to produce what was once considered nonproductive oil and gas formations. This hydraulic fracturing technology requires the use of high volumes of water to be pumped into the wells under tremendous rates and pressures to pry the rock apart allowing the oil and gas that is trapped within the matrix of these formations to migrate to the wellbore and production casing. Although the use of this technology has allowed high volumes of oil and gas recovery from these formations, the use of these large volumes of water has been widely scrutinized. Because the water that is used during these fracturing operations must be clean and free from contaminates current technologies use fresh water sources that are normally used for irrigation and human consumption. The use of these fresh water supplies has begun to have an impact on the availability of fresh water for human consumption and irrigation. Although the water that is pumped into these formations is recovered over the production life of the oil and gas well the water becomes contaminated with chemicals from the fracturing process and minerals that are leached from the producing reservoir during the production of the well. Most oil and gas reservoirs were created from decomposed organic matter generated from oceanic seabed. This fresh water mixes with the salt water that is typically produced from the hydrocarbon formations

2. Description of Related Art

Currently there are several methods in use for handling flow back fluids. One such method is that the water that is produced or that flows back from the well is then disposed of by pumping it into deep nonproductive oil and gas formations. This cycle is repeated for each well and can use hundreds of thousands of barrels for each operation. This process and reduced fresh water supplies have generated a need for an economic technology that can clean these large volumes of water generated by the flow-back and production of these wells to allow the water to be reused instead of disposed of thereby reducing the burden that is placed on fresh water supplies. The industry has tried multiple technologies to clean and repurpose this water and although somewhat successful in certain areas the complexity of the water from area to area and even well to well has made it almost impossible for companies to provide a stable solution that can address these wide variations of water conditions. The technology must be capable of handling high volumes of suspended solids such as polymers and chemicals as well as the smaller dissolved solids such as iron, salts and other minerals. The problem with this wide range in particle size and volume of solids has made handling this material very difficult. And although technologies such as Reverse Osmosis Membrane systems or molecular filters have been used to separate these small particles from the water they are not designed to handle high levels of solids or chlorides. This is further compounded by the nature of very small droplets of oil being entrained with in the body of the water. This oil that coexists within this produced water can be up to five percent by volume and causes these Membranes to degrade and fail. Therefore the industry has been left with using methods that were developed for wastewater treatment of municipals. These technologies use large capacity retention ponds and polymers along with microbes to digest and separate the solids from the water. And although this technology has worked for years in the municipal areas it was never designed to handle the types of materials associated with produced oil and gas water.

That combined with the large retention requirements and the high volumes that need to be processed has made these techniques of treatment and settling mostly ineffective for this application. Therefor the need to develop a water treatment technology that can handle these high volumes of both liquid and solids that is not affected by the entrained oil and does not require large retention reservoirs for settling of the solids is needed.

### BRIEF SUMMARY OF THE INVENTION

The present invention is a method and apparatus for treating flow back fluids that include the following.

First the pH level of the flow back fluid is measured and adjusted to be above approximately 7.5. At this point a small volume of an oxidizing agent such as hydrogen peroxide is introduced into the water until the redox potential reaches a value of at least 600 mv. This will cause any iron in the fluid to solidify. Additionally, a varying amount of hydroxyl free radicals are produced which destroys and converts many of the dissolved solids.

The flow back fluid is then passed through a tubing bundle which may include a plurality of straight sections interconnected by 180° tubular bends which further aids the oil/water separation process.

From the tubing bundle the fluid is directed to an oil/water separating unit which may include a coalescing element which may include a plurality of coalescing plastic tubes in removable baskets which facilitate the formation of large oil droplets that will float to the top of the separator. From there, the separated water may be directed to a further treatment component for further purification, such as a reverse osmosis membrane for drinking or other purposes. Also, water can be collected from the reuse in a subsequent fracturing procedure.

Furthermore, In addition to the preceding write up, a unique reaction occurs due to the electromechanical process of the reactor. This occurs when the peroxide is introduced into the moving body of water at an elevated atmosphere pressure for example from about 15 to 50 psi. One of the net results is that less hydrogen peroxide is required in the process thereby reducing costs. This elevated atmosphere not only prevents H2S from liberating itself from the water, reducing volumetric dosage ratios by keeping the peroxide in solution longer by preventing boil off thereby making it more effective at very low dosage rates, but also small residual amounts of ozone are generated by the free ions that become disassociate during the decomposition of the Hydrogen peroxide. This then reacts with the free electrons that occur due to the interfacial surface tension of the conduit, which then become attached to the interior of the conduit mixing with the ions in the presence of the monatomic oxygen thereby producing small quantities of Ozone. This residual Ozone has been measured during testing and amplifies the effect of the Hydrogen peroxide during the water treatment process.

Furthermore the hydrogen peroxide is excellent at reducing the bacterial loading of the water. Even waters with significant levels of biological activity are made effectively sterile by the peroxide addition thereby reducing the biocide loading requirements during Frac operations.

### BRIEF DESCRIPTION OF THE SEVERAL VIEWS OF THE DRAWING(S)

FIG. 1A is a schematic view of a portion of the treatment process and apparatus according to an embodiment of the invention.

FIG. 1B is a schematic view of a second portion of the treatment process and apparatus according to an embodiment of the invention.

### DETAILED DESCRIPTION OF THE INVENTION

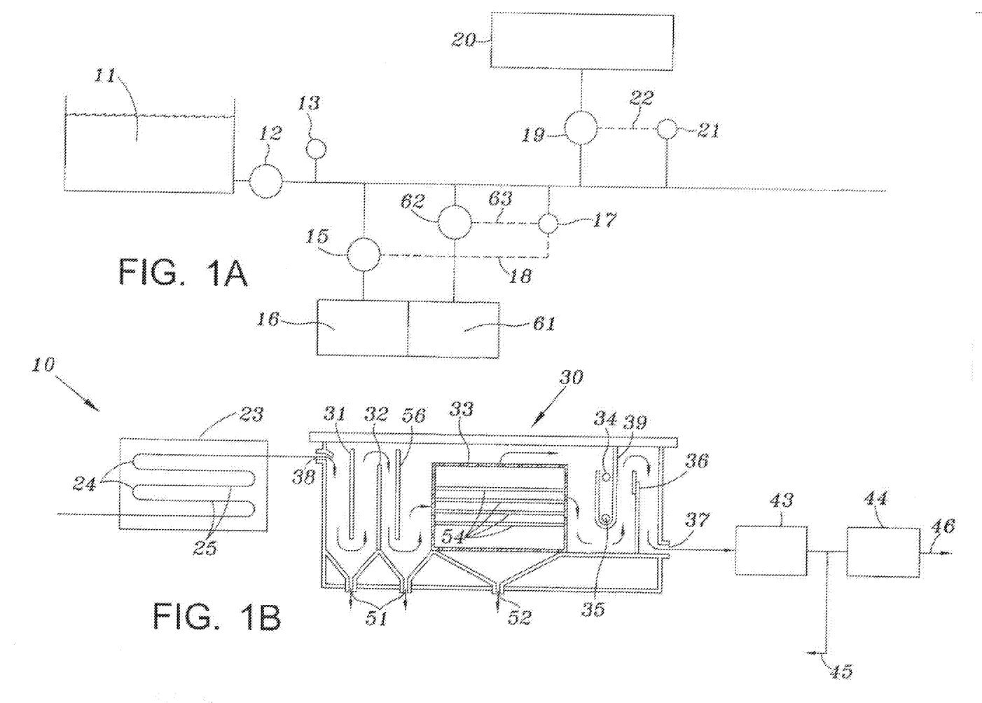

Referring to FIG. 1A, a reservoir 11 for flow back fluid from a well completion process such as fracturing is provided at the well site to contain the flow back fluid which mainly consists of water. It also includes dissolved solids, proppant, solids and well completion chemicals. In addition to the fresh water used for fracing, salt water from the formation is also typically produced back.

Flow back fluid is conveyed from reservoir 11 by a suitable pump 12. A flow meter 13 measures the flow rate of the fluid. A dual reservoir 16 and 61 for acidic and alkali mixtures is connected to metering pumps 15 and 62 which may be variable speed electric pumps to introduce the appropriate amount of mixture to adjust the pH of the fluid to about 7.5. The pH of the fluid is monitored by a sensor 17 and a feedback control circuit 18 and 63 may send a signal to the metering pumps 15 and 62 to adjust the amount of material being added. An example of a metering system is disclosed in U.S. Patent Application Publication No. 2012/0127822A1, the entire contents of which is hereby incorporated herein by reference thereto.

Once the pH of the fluid is at about 7.5, a small amount of an oxidizing agent such as hydrogen peroxide is introduced into the fluid by a metering pump 19 which is connected to a reservoir 20 containing the oxidizing agent. A sensor 21 measures the oxidative redox potential of the water and the amount of added oxidizing agent is adjusted by a signal 22 to metering pump so that the potential reaches a value of at least 600 mw with the pH at 7.5 plus or minus one.

At a PH above 7 the oxidizing agent begins to convert the soluble Fe2 to its insoluble form (Fe3) thus allowing the iron to be more readily removed by downstream means. The treatment also aids in destroying bacteria and dissolved solids such as organic pollutants, BOD, COD and reducing toxicity levels. This oxidative process additionally disrupts the water by releasing an oxygen molecule during the iron conversion process and producing a varying amount of hydroxyl free radicals. This not only destroys and converts many of the dissolved solids but it causes a reduction in the density of the water thereby helping the small droplets of oil that are contained within the water to separate away from the main body of the water.

After the addition of the oxidizing agent, the fluid is passed through a tubing bundle 23 shown in FIG. 1B similar to the one disclosed in the above identified patent application publication. It includes a plurality of straight sections 25 and a plurality of 180° elbow bends 24. It may also include a plurality of static mixers such as swirl vanes. This further encourages the oil and solid particles to disassociate from the water and eliminates the need for retention tanks commonly associated with conventional water treatment.

From the tubing bundle, the fluid is directed into an oil water separator unit 30 that includes a coalescing unit 33 that includes a plurality of coalescing tubes 54 made from polypropylene. Unit 33 may be an open basket with tubes 54 positioned within the basket that is removably placed within the separator.

Fluid to be treated enters unit 30 at 38 and is directed under a baffle plate 31 and over a weir plate 32. A second baffle plate 56 is positioned between weir plate 32 and coalescing unit 33. Coalescing tubes 54 promote the oil to form large droplets which rise to the top. Oil is removed from the top of the separator through outlet 34. Water is directed under U-shaped baffle 39 and flows over an adjustable baffle 36. Water is removed from separator 30 through outlet 37. Any water that accumulates in baffle 39 exits out through port 35. Solids that accumulate at the bottom of the separator can be removed through outlets 51 and 52. An example of a separator is the TPL Phase 3 coalescing Type Oil/Water Separator sold by Flo Trend Systems Inc. of Houston, Tex. Water exiting the separator can then be directed to storage tanks and or further treatment devices as shown at 44, 43. Treated fluid can be directed to other locations via conduits 45, 46.

Although the present invention has been described with respect to specific details, it is not intended that such details should be regarded as limitations on the scope of the invention, except to the extent that they are included in the accompanying claims.

We claim:

1. A method of treating flow back fluid from a well completion process wherein the flow back fluid contains water, solids, dissolved solids and oil comprising:
a) conveying the flow back fluid via a conduit,
b) maintaining the pH level of the fluid back fluid above about 7.5,
c) adding an oxidizing agent to the flow back fluid at a pressure greater than atmospheric pressure until the redox potential of the flow back fluid reaches a value of at least 600 mv,
d) passing the flow back fluid through an oil/water separator having a coalescing unit and,
e) collecting the water from the separator for reuse.

2. A method according to claim 1 further including directing the water from the separator separating device to a desalting device.

3. A method according to claim 2 wherein the desalting device is a reverse osmosis membrane apparatus.

4. A method according to claim 1 further including passing the flow back fluid through a tubing bundle prior to the flow back fluid entering the oil/water separator.

5. The method of claim 1 wherein the oxidizing agent is introduced into the flow back fluid at a pressure greater from about fifteen to fifty psi.

6. Apparatus for treating flow back fluid from a well after a completion process has been performed comprising:
a reservoir for containing a substance which will adjust the pH of the flow back fluid,
a metering device for dispensing a controlled amount of the substance into the flow back fluid,
a tubing bundle having an inlet and an outlet through which the flow back fluid flows,
an oil/water separator having an inlet connected to the outlet of the tube bundle. and an outlet. The apparatus of claim 7 further includes a reservoir containing the substance and a metering pump for introducing the substance into the flow back fluid.

7. Apparatus as claimed in claim 7 wherein the oil/water separator includes an oil coalescing unit comprising a plurality of tubes.

8. A method as claimed in claim 1 wherein the oxidizing agent is hydrogen peroxide.
